(19) United States
(12) Patent Application Publication
(10) Pub. No.: US 2026/0296850 A1
(43) Pub. Date: Oct. 1, 2026

(54) Parasitic Hydraulic Jack System

(71) Applicants: Raed Almashaqbeh, Clifton, NJ (US); Rami Misbah Tahah, Bronx, NY (US)

(72) Inventors: Raed Almashaqbeh, Clifton, NJ (US); Rami Misbah Tahah, Bronx, NY (US)

(21) Appl. No.: 19/097,426

(22) Filed: Apr. 1, 2025

(51) Int. Cl. B66F 3/32; B66F 3/42

(52) U.S. Cl. CPC B66F 3/32; B66F 3/42; B66F 2700/05

(57) ABSTRACT

The parasitic hydraulic jack system includes a set of shock absorbers each with a hydraulic fluid (HF) and a HF port configured to pass a volume of HF into and out of each shock absorber, a respective set of hydraulic pumps each with an electronic actuator (HFPA) configured to control the extension and compression of the shock absorber via the volume, and a remote control unit (RCU) configured to wirelessly control each extension and compression of the respective shock absorber via the respective HFPA. The hydraulic pump(s) can raise or lower any of four jacks without affecting the other three via a user-operated remote control. The control also has a locking feature whereby the jacks will not alter their height until the control is unlocked. An embodiment includes a central hydraulic pump mounted on the bottom of the vehicle.

### BACKGROUND

The most common form is a car jack, floor jack or garage jack, which lifts vehicles so that maintenance can be performed. Jacks are usually rated for a maximum lifting capacity. Hydraulic jacks are typically used for shop work, rather than as an emergency jack to be carried with the vehicle. Use of jacks not designed for a specific vehicle requires more than the usual care in selecting ground conditions, the jacking point on a vehicle, and to ensure stability when the jack is extended. There have been no products available as original equipment or as an aftermarket to address this problem.

National and international standards have been developed to standardize the safety and performance requirements for jacks and other lifting devices. Selection of the standard is an agreement between the purchaser and the manufacturer, and has some significance in the design of the jack. There have been no products available as original equipment or as an aftermarket to address this problem either.

There exists a need for a mounted hydraulic jack system that is not being met by any known or disclosed device or system of present.

### SUMMARY OF THE INVENTION

The hydraulic jack system includes a set of shock absorbers each with a hydraulic fluid (HF) and a HF port configured to pass a volume of HF into and out of each shock absorber, a respective set of hydraulic pumps each with an electronic actuator (HFPA) configured to control the extension and compression of the shock absorber via the volume, and a remote control unit (RCU) configured to wirelessly control each extension and compression of the respective shock absorber via the respective HFPA.

The disclosed hydraulic jack system uses four independent jacks strategically mounted on the four corners of the bottom of a vehicle. An embodiment includes a central hydraulic pump, also mounted on the bottom of the vehicle. The hydraulic pump(s) can raise or lower any of the four jacks without affecting the other three. This hydraulic pump is controlled by a user-operated remote control whereby the user can directly adjust the height of the four jacks. The control also has a locking feature whereby the jacks will not alter their height until the control is unlocked. As a safety precaution, the pump cannot be utilized unless the vehicle brakes are applied.

### BRIEF DESCRIPTION OF THE DRAWINGS

FIG. 1A is a cutaway view of the parasitic hydraulic jack in compression in accordance with an embodiment of the present disclosure.

FIG. 1B is a cutaway view of the parasitic hydraulic jack in extension in accordance with an embodiment of the present disclosure.

FIG. 2 is a parasitic view of the parasitic jacks in place in a vehicle in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘central’ is used to refer to a hydraulic pump which is both physically central to the hydraulic jacks and also hydraulically central to the hydraulic jacks. The term wirelessly refers to devices, apparatuses and methods of operation and control via electromagnetic waves in the full spectrum of visible, invisible, short wave, long wave and other lengths known to a person of ordinary skill in the art. The term ‘intelligent,’ refers to an ability to control and operate the disclosure via circuits, electronic memory, software applications and methods as disclosed herein. The term ‘parasitic’ refers to the hydraulic jack system using existing equipment in standard original equipment manufacture of vehicles such as shock absorbers.

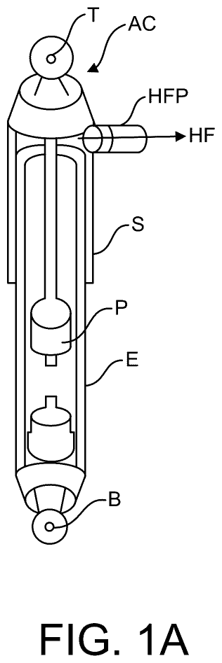

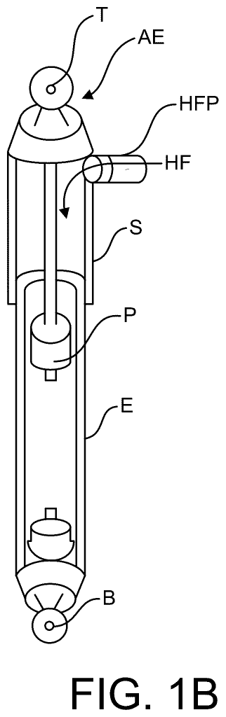

FIG. 1A is a cutaway view of the parasitic hydraulic jack in compression in accordance with an embodiment of the present disclosure. The view includes the parasitic jack or shock absorber AC in compression under load, the Top connection, the hydraulic fluid (HF) port HFP, the shell S, the piston P, the extension sleeve E, and the bottom connection B. The hydraulic fluid HF passes into and out of the HFP to raise/lower, extend and compress the extension or inner sleeve into and out of the outer sleeve S to jack up the vehicle or to cushion its ride in normal operation. Therefore, since the HFP is a modification to an existing shock absorber, the hydraulic jack is referred to as parasitic.

FIG. 1B is a cutaway view of the parasitic hydraulic jack in extension in accordance with an embodiment of the present disclosure. The view includes the parasitic jack or shock absorber AE in extension under load, the Top connection, the hydraulic fluid (HF) port HFP, the shell S, the piston P, the extension sleeve E, and the bottom connection B. The hydraulic fluid HF passes into and out of the HFP to raise/lower, extend and compress the extension or inner sleeve into and out of the outer sleeve S to jack up the vehicle or to cushion its ride in normal operation. Therefore, since the HFP is a modification to an existing shock absorber, the hydraulic jack is referred to as parasitic. An elongated sleeve and an elongated extension are also included in embodiments relative to a standard OEM shock absorber. The coils are not shown for simplicity.

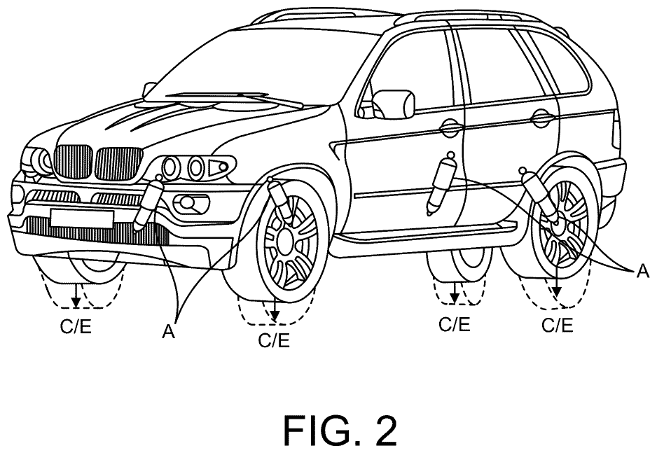

FIG. 2 is a perspective view of the parasitic hydraulic jacks in place in a vehicle in accordance with an embodiment of the present disclosure. The vehicle to which the system is attached appears transparent to make seeing the jack system on the vehicle's underbelly possible in accordance with an embodiment of the present disclosure. Each of the four jacks A is stationed at a different corner of the vehicle corresponding to each wheel. Each jack operates independently of the others, but is connected to a central control unit C which is a hydraulic pump in embodiments. There is a hydraulic hose connection B which runs from the central hydraulic pump to each of the four jacks.

The parasitic hydraulic jack comprises a set of hydraulic pumps and shock absorbers comprising a front left hydraulic pump and shock absorber and a front right hydraulic pump and shock absorber. Also, a set of hydraulic pumps and shock absorbers comprise a right rear hydraulic pump and shock absorber and a left rear hydraulic pump and shock absorber.

A lock button on the remote control configured to lock the extension/compression of the shock absorber into a predetermined position. The remote control is configured to wirelessly control a plurality of HFPA simultaneously and in parallel. The remote control is also preconfigured to wirelessly control a plurality of HFPA consecutively and in seriehe remote control is configured to wirelessly control each of the HFPA according to a preset sequence. Additionally, a logic circuit controls an operation of the system via the remote control based on an indication a vehicle's brakes are applied. Embodiments of the remote control include a cell phone.

In other words, a parasitic hydraulic jack system includes a set of existing shock absorbers each with a hydraulic fluid (HF) and a HF port configured to pass a volume of HF into and out of each existing shock absorber, a respective set of hydraulic pumps each with an electronic actuator (HFPA) configured to control the extension and compression of the existing shock absorber via the volume and a remote control unit (RCU) configured to wirelessly control each extension and compression of the respective existing shock absorber via the respective HFPA.

The parasitic HJS includes a front left hydraulic pump, a front right hydraulic pump, a right rear hydraulic pump and a left rear hydraulic pump and a central hydraulic reservoir (CHR) configured to supply the HF to each of the respective set of hydraulic pumps under control of the RCU. Alternatively, a central hydraulic pump (CHP) is configured to supply the HF under pressure to the respective HF ports of the set of existing shock absorbers.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A hydraulic jack comprising:
an existing shock absorber with a hydraulic fluid (HF) and a HF port configured to increase and decrease an amount of HF in the shock absorber;
a hydraulic pump with an electronic actuator configured to increase and to decrease the HF and extension/compression of the shock absorber via the HF port; and
a remote control configured to wirelessly control the extension/compression of the shock absorber via the HF port and electronic actuator (HFPA).

2. The hydraulic jack of claim 1, further comprising a set of hydraulic pumps and shock absorbers comprising a front left hydraulic pump and shock absorber and a front right hydraulic pump and shock absorber.

3. The hydraulic jack of claim 1, further comprising a set of hydraulic pumps and shock absorbers comprising a right rear hydraulic pump and shock absorber and a left rear hydraulic pump and shock absorber.

4. The hydraulic jack of claim 1, further comprising a lock button on the remote control configured to lock the extension/compression of the shock absorber into a predetermined position.

5. The hydraulic jack of claim 1, wherein the remote control is configured to wirelessly control a plurality of HFPA simultaneously and in parallel.

6. The hydraulic jack of claim 1, wherein the remote control is configured to wirelessly control a plurality of HFPA consecutively and in series.

7. The hydraulic jack of claim 1, wherein the remote control is configured to wirelessly control each of the HFPA according to a preset sequence.

8. The hydraulic jack of claim 1, further comprising a HFPA for a front left of a vehicle, a HFPA for a front right of the vehicle, a HFPA for a rear left of the vehicle and a HFPA for a rear right of the vehicle.

9. The hydraulic jack of claim 1, further comprising a logic circuit which controls an operation of the system via the remote control based on an indication a vehicle's brakes are applied.

10. The hydraulic jack of claim 1, wherein the remote control is a cell phone.

11. A hydraulic jack system comprising: a set of existing shock absorbers each with a hydraulic fluid (HF) and a HF port configured to pass a volume of HF into and out of each existing shock absorber; a respective set of hydraulic pumps each with an electronic actuator (HFPA) configured to control the extension and compression of the existing shock absorber via the volume; and a remote control unit (RCU) configured to wirelessly control each extension and compression of the respective existing shock absorber via the respective HFPA.

12. The hydraulic jack system (HJS) of claim 11, wherein the HJS respective set of hydraulic pumps comprises a front left hydraulic pump, a front right hydraulic pump, a right rear hydraulic pump and a left rear hydraulic pump.

13. The hydraulic jack system (HJS) of claim 11, wherein the HJS set of existing shock absorbers comprises a front left existing shock absorber with an HF port and a front right existing shock absorber with an HF port.

14. The hydraulic jack system of claim 11, further comprising a central hydraulic reservoir (CHR) configured to supply the HF to each of the respective set of hydraulic pumps under control of the RCU.

15. The hydraulic jack system of claim 11, further comprising a central hydraulic pump (CHP) configured to supply the HF under pressure to the respective HF ports of the set of existing shock absorbers.
